(19) United States
(12) Patent Application Publication
(10) Pub. No.: US 2022/0168966 A1
(43) Pub. Date: Jun. 2, 2022

(54) Method of Integral Hot-Melt Adhesion of a Bicycle Saddle

(71) Applicant: Foming Bicycle Parts Co., Ltd., Fuxing Township (TW)

(72) Inventor: Shang-Tsang Tsai, Fuxing Township (TW)

(21) Appl. No.: 17/106,267

(22) Filed: Nov. 30, 2020

(51) Int. Cl. B29C 65/54; B29C 65/48

(52) U.S. Cl. CPC B29C 65/544; B29L 2031/3094; B29C 65/4815

(57) ABSTRACT

A method of integral hot-melt adhesion of a bicycle saddle contains steps of: a) providing material; b) putting the material into at least one mold; c) inserting a heating plate; d) melting; e) removing the heating plate; f) hot-melting adhesion; and g) taking out. Thereby, the body includes the rubber shell, the flexible layer, and the covering layer. The rubber shell is connected with the support shell by a hot-melting manner so that a peripheral side of the covering layer is bent to and is connected on the bottom of the rubber shell, thus obtaining a security, a smooth appearance, a moisture-proof purpose, a waterproof purpose, a shock absorption, a heat dissipation, an easy cleaning, and a low fabrication cost.

### BACKGROUND OF THE INVENTION

### Field of the Invention

The present invention relates to a method of making a bicycle saddle, and more particularly to a method of integral hot-melt adhesion of a bicycle saddle.

### Description of the Prior Art

A conventional bicycle saddle is applicable for a foot drive device, such as a bicycle or an exercise bike, so as to support a user. The bicycle saddle contains a support shell, a covering layer, and a flexible layer. The flexible layer is defined between the support shell and the covering layer, wherein the support shell is configured to support the user and to connect the bicycle saddle on the foot drive device by using a fixing device, and the covering layer (made of synthetic plastic) is configured to contact the user's body. In addition, the flexible layer is applied to provide flexibility and shocking absorption.

A conventional method of making the bicycle saddle contains steps of providing the support shell, the covering layer, and the flexible layer. The flexible layer is connected on the support shell by an adhesive manner or by ways of at least one, the covering layer is covered on a top of the flexible layer and is pulled tightly so as to contact with the flexible layer matingly, and a peripheral side of the covering layer is bent reversely to a bottom of the support shell and is fixed on the support shell by using a glue or at least one nail.

However, the peripheral side of the covering layer exposes outside the bottom of the support shell to cause poor appearance. Furthermore, the peripheral side of the covering layer is moved easily to remove, thus adhesion the bicycle saddle insecurely.

The present invention has arisen to mitigate and/or obviate the afore-described disadvantages.

### SUMMARY OF THE INVENTION

The primary object of the present invention is to provide method of integral hot-melt adhesion of a bicycle saddle which obtains a security, a smooth appearance, a moisture-proof purpose, a waterproof purpose, a shock absorption, a heat dissipation, an easy cleaning, and a low fabrication cost.

To obtain above-mentioned aspect, a method of integral hot-melt adhesion of a bicycle saddle provided by the present invention contains steps of:

a) providing material, wherein a body and a support shell of the bicycle saddle are provided, the body includes a rubber shell, a flexible layer connected on the rubber shell, and a covering layer covered on the flexible layer, wherein a peripheral side of the covering layer is bent to and is connected on a bottom of the rubber shell, the rubber shell of the body has multiple first hot-melt strips arranged on the bottom of the rubber shell, and the support shell includes multiple second hot-melt strips arranged on a top thereof;

b) putting the material into at least one mold, wherein the body is reversely put into a first mold, the support shell is reversely put into a second mold, and the support shell is mounted by the second mold in a vacuum absorbing manner;

c) inserting a heating plate, wherein a heating plate is heated within a predetermined temperature range and is inserted between the second mold and the first mold;

d) melting, wherein the second mold is moved downward, and the first mold is moved upward so that the second mold and the first mold are close to the heating plate, wherein the multiple hot-melt strips of the rubber shell of the body contact with the heating plate, the multiple second hot-melt strips of the support shell contact with the heating plate, and the heating plate heats the multiple first hot-melt strips and the multiple second hot-melt strips in a first predetermined time, thus hot-melting the multiple first hot-melt strips and the multiple second hot-melt strips;

e) removing the heating plate, wherein the first mold is moved upward, and the second mold is moved downward, such that the heating plate is removed outward;

f) hot-melting adhesion, wherein the second mold is moved downward, and the first mold is moved upward, such that the second mold is moved to contact with the first mold, wherein the heating plate heats within a second predetermined time so as to hot-melt connect the multiple first hot-melt strips and the multiple second hot-melt strips integrally, thus adhesion the rubber shell with the support shell; and

g) taking out, wherein the second mold is stopped absorbing the support shell and is moved upward, and the first mold is moved downward, thus taking a finished product.

### BRIEF DESCRIPTION OF THE DRAWINGS

FIG. 1 is a flow chart of a method of integral hot-melt adhesion of a bicycle saddle according to a preferred embodiment of the present invention.

FIG. 2 is a perspective view showing the exploded components of a body of the bicycle saddle according to the preferred embodiment of the present invention.

FIG. 3 is a perspective view showing the exploded components of the body and a support shell of the bicycle saddle according to the preferred embodiment of the present invention.

FIG. 4 is a side plan view showing the body being put into a first mold and the support shell being put into a second mold according to the preferred embodiment of the present invention.

FIG. 5 is a side plan view showing a heating plate being inserted between the second mold and the first mold according to the preferred embodiment of the present invention.

FIG. 6 is a side plan view showing a heating step according to the preferred embodiment of the present invention.

FIG. 7 is a cross sectional view showing the heating step according to the preferred embodiment of the present invention.

IG. 8 is a side plan view showing the heating step being taken out according to the preferred embodiment of the present invention.

FIG. 9 is a side plan view showing a hot-melting step according to the preferred embodiment of the present invention.

FIG. 10 is a cross sectional view showing the hot-melting step according to the preferred embodiment of the present invention.

FIG. 11 is a perspective view showing the assembly of a finished product according to the preferred embodiment of the present invention.

FIG. 12 is a top plan view showing the assembly of the body of the bicycle saddle according to the preferred embodiment of the present invention.

FIG. 13 is a bottom plan view showing the assembly of the support shell of the bicycle saddle according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

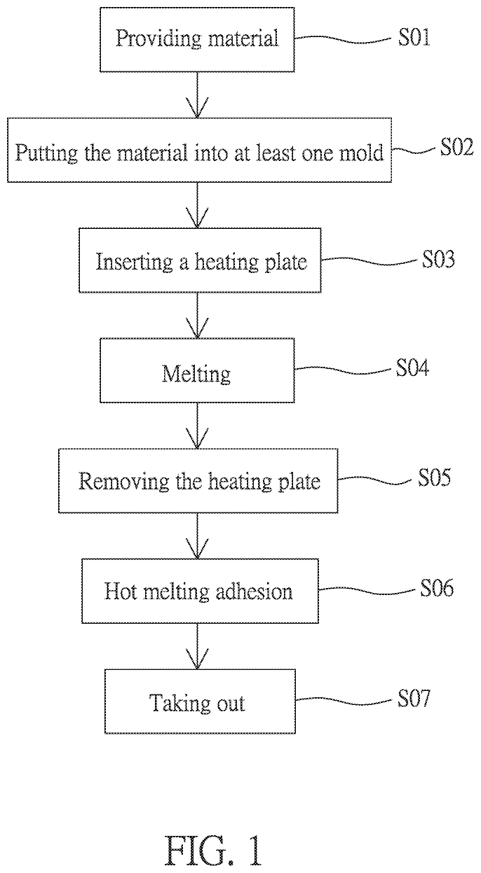

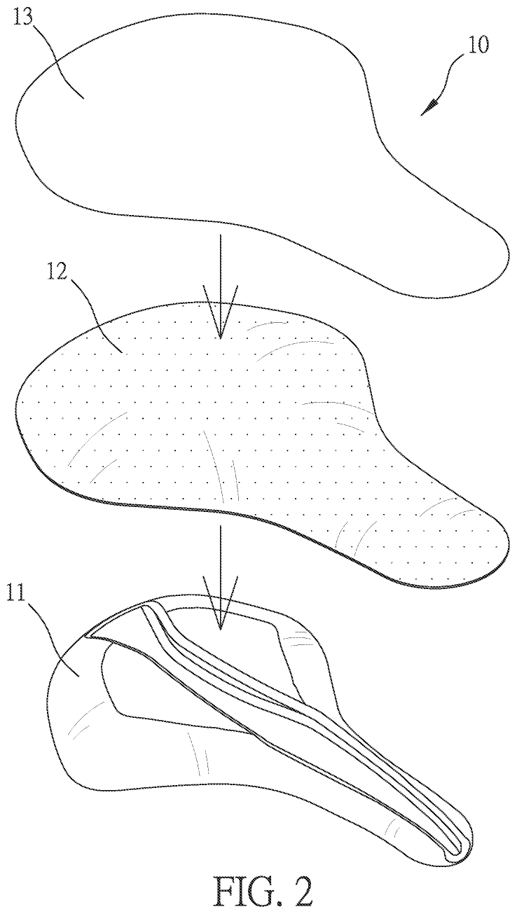

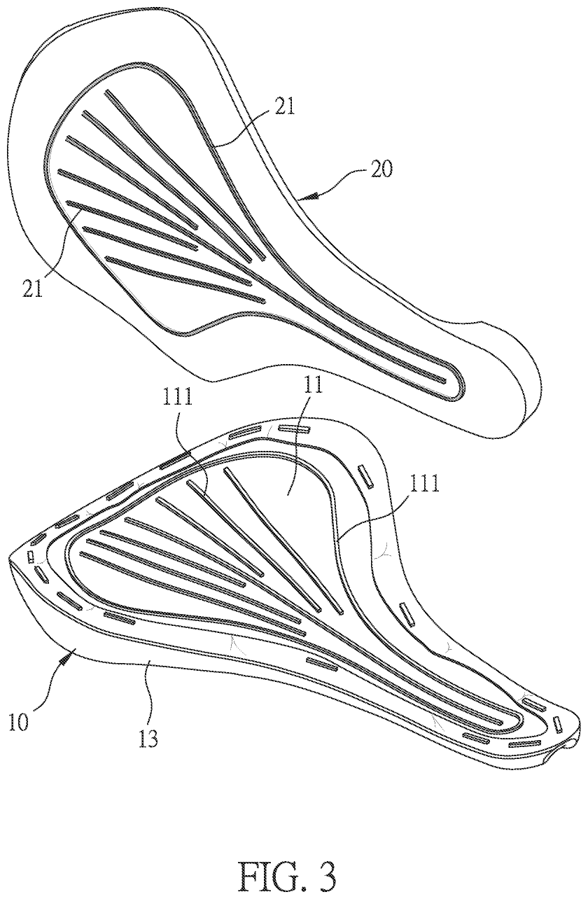

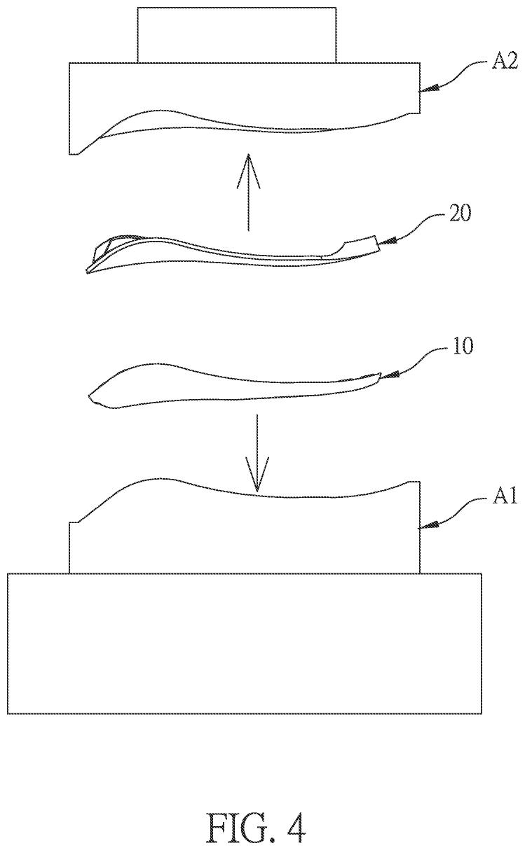

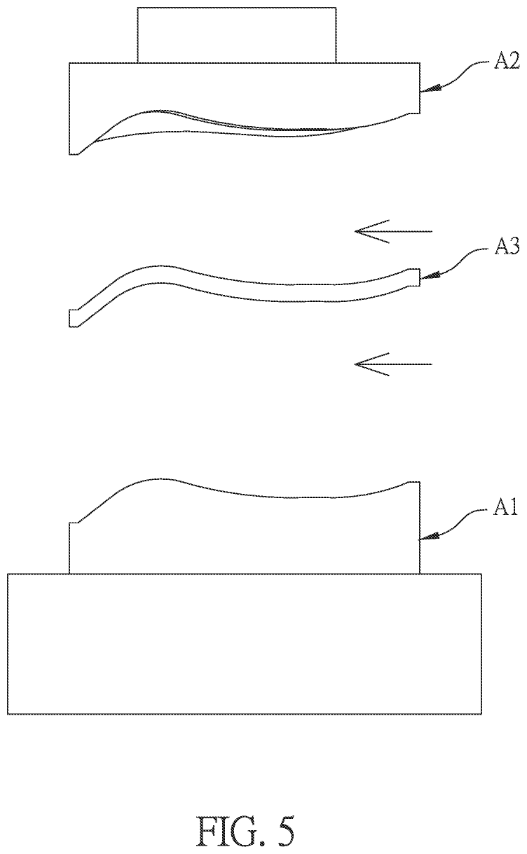

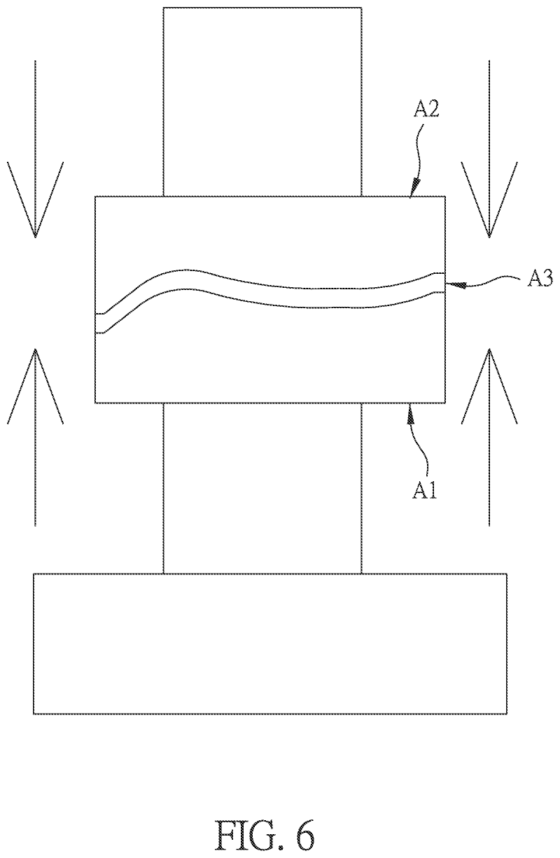

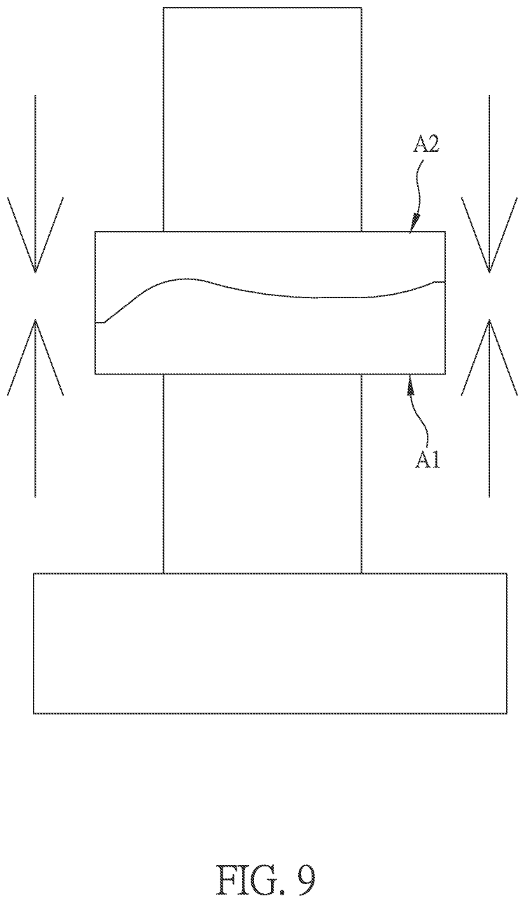

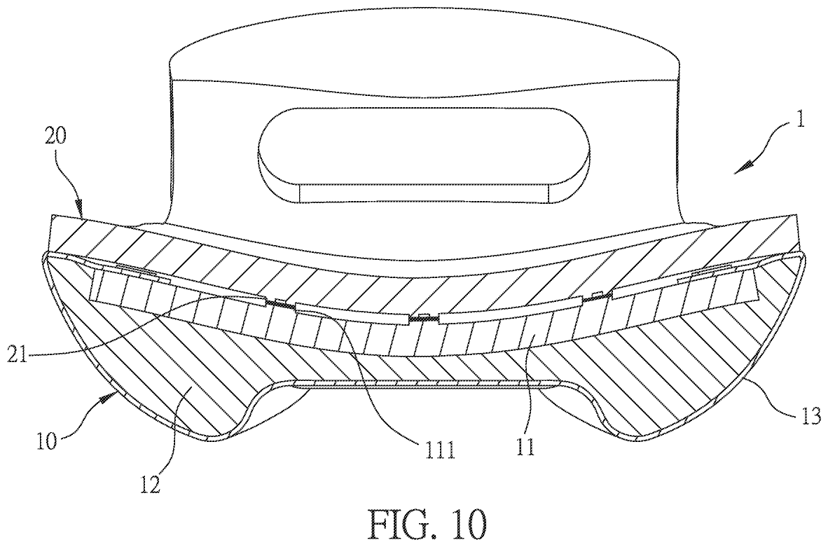

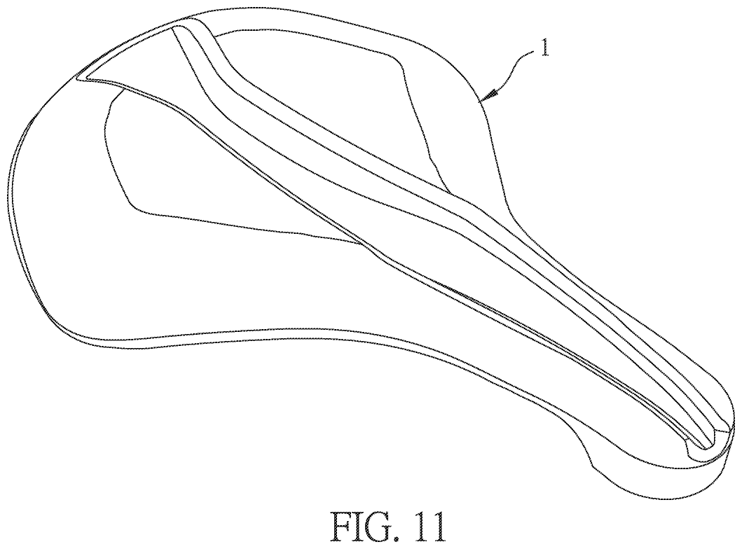

With reference to FIGS. 1-11, a method of integral hot-melt adhesion of a bicycle saddle according to a preferred embodiment of the present invention comprises steps of:

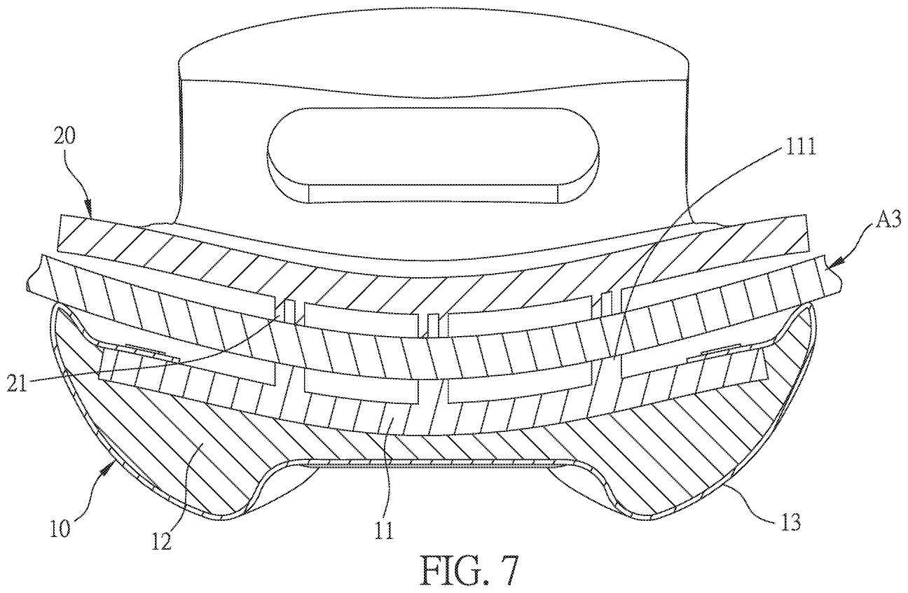

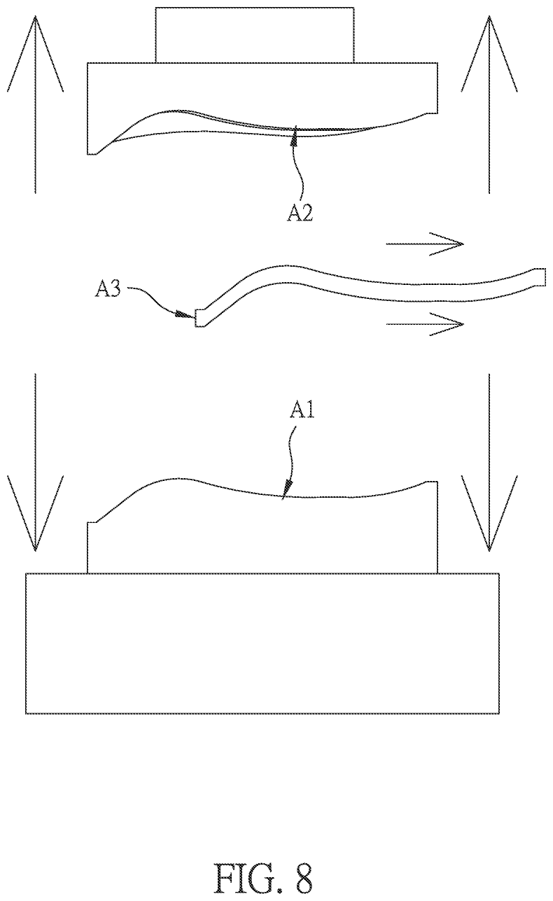

a) providing material S01, wherein a body 10 and a support shell 20 of the bicycle saddle are provided, the body 10 includes a rubber shell 11, a flexible layer 12 connected on the rubber shell 11, and a covering layer 13 covered on the flexible layer 12, wherein a peripheral side of the covering layer 13 is bent to and is connected on a bottom of the rubber shell 11 by using a glue or at least one nail, the rubber shell 11 of the body 10 has multiple first hot-melt strips 111 arranged on the bottom of the rubber shell 11, and the support shell 20 includes multiple second hot-melt strips 21 arranged on a top thereof, wherein the multiple first hot-melt strips 111 correspond to or are not aligned with the multiple second hot-melt strips 21, and the multiple first hot-melt strips 111 and the multiple second hot-melt strips 21 are formed in a circle shape or a strip shape, wherein a cross section of a respective first hot-melt strip 111 is solid and is formed in a rectangle shape, and referring to FIG. 7 a cross section of a respective second hot-melt strip 21 is separated in the middle to be formed of two blocks;

b) putting the material into at least one mold S02, wherein the body 10 is reversely put into a first mold A1, the support shell 20 is reversely put into a second mold A2, and the support shell 20 is mounted by the second mold A2 in a vacuum absorbing manner;

c) inserting a heating plate S03, wherein a heating plate A3 is heated within a temperature range of 200° C. to 400° C. and is inserted between the second mold A2 and the first mold A1;

d) melting S04, wherein the second mold A2 is moved downward, and the first mold A1 is moved upward so that the second mold A2 and the first mold A1 are close to the heating plate A3, wherein the multiple hot-melt strips 111 of the rubber shell 11 of the body 10 contact with a first surface of the heating plate A3, the multiple second hot-melt strips 21 of the support shell 20 contact with a second surface of the heating plate A3, and the heating plate A3 heats the multiple first hot-melt strips 111 and the multiple second hot-melt strips 21 within a first predetermined hot-melt time (such as 10 seconds to 20 seconds), thus hot-melting the multiple first hot-melt strips 111 and the multiple second hot-melt strips 21;

e) removing the heating plate S05, wherein the first mold A2 is moved upward, and the second mold A1 is moved downward, such that the second mold A1 is kept a distance away from the first mold A2 and the heating plate A3 so as to be removed outward;

f) hot-melting adhesion S06, wherein the second mold A2 is moved downward, and the first mold A1 is moved upward, such that the second mold A2 is moved to contact with the first mold A1, the multiple first hot-melt strips 111 of the bottom of the rubber shell 11 abut against a top of the support shell 20, and the multiple second hot-melt strips 21 of the top of the support shell 20 contact with the bottom of the rubber shell 11, wherein the heating plate A3 heats the multiple first hot-melt strips 111 and the multiple second hot-melt strips 21 within a second predetermined hot-melt time (such as 5 seconds to 15 seconds) so as to hot-melt connect the multiple first hot-melt strips 111 and the multiple second hot-melt strips 21 integrally, thus adhesion the rubber shell 11 with the support shell 20;

g) taking out S07, wherein the second mold A2 is stopped absorbing the support shell 20 by the vacuum absorbing and is moved back to an original position upward, and the first mold A1 is moved back to an original position downward, thus taking out a finished product 1.

The bicycle saddle of the present invention contains the body 10 and the support shell 20.

The body 10 includes the rubber shell 11, the flexible layer 12 connected on the rubber shell 11, and the covering layer 13 covered on the flexible layer 12, wherein the peripheral side of the covering layer 13 is bent to and connected on the bottom of the rubber shell 11 by using the glue or the at least one nail, the rubber shell 11 of the body 10 has the multiple first hot-melt strips 111 arranged on the bottom of the rubber shell 11, the support shell 20 includes the multiple second hot-melt strips 21 arranged on the top thereof, wherein the multiple first hot-melt strips 111 correspond to or are not aligned with the multiple second hot-melt strips 21, the body 10 is integrally connected on the support shell 20 by ways of the multiple first hot-melt strips 111 and the multiple second hot-melt strips 21 in a hot-melting manner.

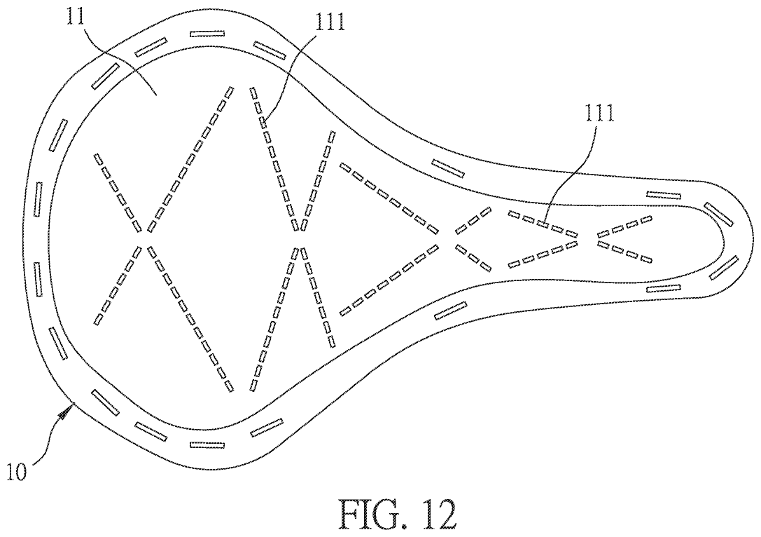

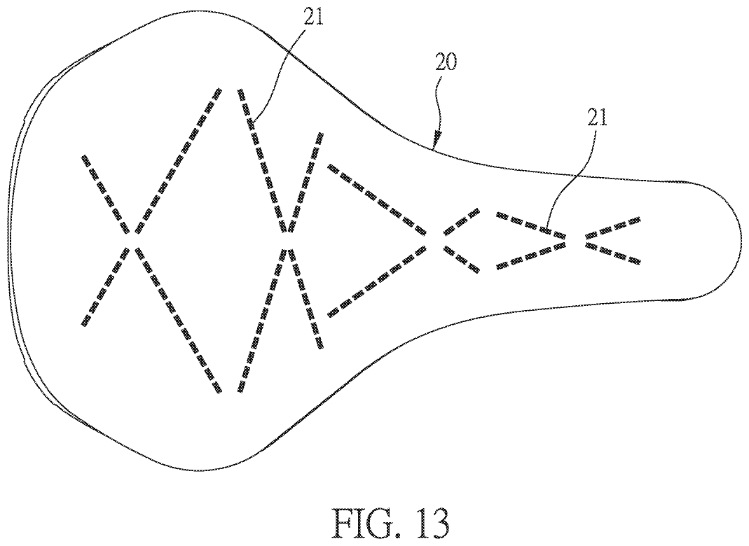

Referring to FIGS. 12 and 13, in another embodiment, the multiple first hot-melt strips 111 and the multiple second hot-melt strips 21 are arranged intermittently. Alternatively, the multiple first hot-melt strips 111 and the multiple second hot-melt strips 21 are arranged in a predetermined section, wherein the multiple first hot-melt strips 111 correspond to or are not aligned (i.e., are intersected, staggered) with the multiple second hot-melt strips 21.

Thereby, the body 10 includes the rubber shell 11, the flexible layer 12, and the covering layer 13, wherein the rubber shell 11 is adhered with the support shell 20 by the hot-melting manner so that the peripheral side of the covering layer 13 is bent to and is connected on the bottom of the rubber shell 11, thus obtaining a security, a smooth appearance, a moisture-proof purpose, a waterproof purpose, a shock absorption, a heat dissipation, an easy cleaning, and a low fabrication cost.

While various embodiments in accordance with the present invention have been shown and described, it is clear to those skilled in the art that further embodiments may be made without departing from the scope of the present invention.

What is claimed is:

1. A method of integral hot-melt adhesion of a bicycle saddle comprising steps of:
a) providing material, wherein a body and a support shell of the bicycle saddle are provided, the body includes a rubber shell, a flexible layer connected on the rubber shell, and a covering layer covered on the flexible layer, wherein a peripheral side of the covering layer is bent to and is connected on a bottom of the rubber shell, the rubber shell of the body has multiple first hot-melt strips arranged on the bottom of the rubber shell, and the support shell includes multiple second hot-melt strips arranged on a top thereof;
b) putting the material into at least one mold, wherein the body is reversely put into a first mold, the support shell is reversely put into a second mold, and the support shell is mounted by the second mold in a vacuum absorbing manner;
c) inserting a heating plate, wherein a heating plate is heated within a predetermined temperature range and is inserted between the second mold and the first mold;
d) melting, wherein the second mold is moved downward, and the first mold is moved upward so that the second mold and the first mold are close to the heating plate, wherein the multiple hot-melt strips of the rubber shell of the body contact with the heating plate, the multiple second hot-melt strips of the support shell contact with the heating plate, and the heating plate heats the multiple first hot-melt strips and the multiple second hot-melt strips in a first predetermined time, thus hot-melting the multiple first hot-melt strips and the multiple second hot-melt strips;
e) removing the heating plate, wherein the first mold is moved upward, and the second mold is moved downward, such that the heating plate is removed outward;
f) hot-melting adhesion, wherein the second mold is moved downward, and the first mold is moved upward, such that the second mold is moved to contact with the first mold, wherein the heating plate heats within a second predetermined time so as to hot-melt connect the multiple first hot-melt strips and the multiple second hot-melt strips integrally, thus adhesion the rubber shell with the support shell; and
g) taking out, wherein the second mold is stopped absorbing the support shell and is moved upward, and the first mold is moved downward, thus taking out a finished product.

2. The method as claimed in claim 1, wherein a cross section of a respective first hot-melt strip is solid and is formed in a rectangle shape, and a cross section of a respective second hot-melt strip is separated in the middle to be formed of two blocks.

3. The method as claimed in claim 1, wherein the multiple first hot-melt strips correspond to or are not aligned with the multiple second hot-melt strips, and the multiple first hot-melt strips and the multiple second hot-melt strips are formed in a circle shape or a strip shape.

4. The method as claimed in claim 2, wherein the multiple first hot-melt strips correspond to or are not aligned with the multiple second hot-melt strips, and the multiple first hot-melt strips and the multiple second hot-melt strips are formed in a circle shape or a strip shape.

5. The method as claimed in claim 1, wherein the multiple first hot-melt strips and the multiple second hot-melt strips are arranged successively or intermittently or the multiple first hot-melt strips and the multiple second hot-melt strips are arranged in a predetermined section.

6. The method as claimed in claim 2, wherein the multiple first hot-melt strips and the multiple second hot-melt strips are arranged successively or intermittently or the multiple first hot-melt strips and the multiple second hot-melt strips are arranged in a predetermined section.

7. The method as claimed in claim 1, wherein the multiple first hot-melt strips correspond to or are not aligned and intersected with the multiple second hot-melt strips.

8. The method as claimed in claim 2, wherein the multiple first hot-melt strips correspond to or are not aligned and intersected with the multiple second hot-melt strips.

9. The method as claimed in claim 1, wherein the peripheral side of the covering layer is bent to and is connected on the bottom of the rubber shell by using a glue or at least one nail,

10. The method as claimed in claim 1, wherein the temperature range is 200° C. to 400° C.

11. The method as claimed in claim 1, wherein the first predetermined hot-melt time is 10 seconds to 20 seconds.

12. The method as claimed in claim 1, wherein the second predetermined hot-melt time is 5 seconds to 15 seconds.
